(19) United States
(12) Patent Application Publication
(10) Pub. No.: US 2026/0158674 A1
(43) Pub. Date: Jun. 11, 2026

(54) SYSTEMS AND METHODS FOR OBJECT PROCESSING WITH PROGRAMMABLE MOTION DEVICES USING VACUUM PINCHING GRIPPERS

(71) Applicant: Berkshire Grey Operating Company, Inc., Bedford, MA (US)

(72) Inventors: Jeffrey Ian LIPTON, Sharon, MA (US); Bretton ANDERSON, Westford, MA (US); William Chu-Hyon MCMAHAN, North Cambridge, MA (US); Peter Gerard KELLY, Boston, MA (US)

(21) Appl. No.: 19/410,389

(22) Filed: Dec. 5, 2025

Related U.S. Application Data
(60) Provisional application No. 63/728,967, filed on Dec. 6, 2024.

(51) Int. Cl. B25J 13/08

(52) U.S. Cl. CPC B25J 13/082; B25J 13/088

(57) ABSTRACT

An end-effector system for programmable motion devices (e.g., robotic systems) that provides high flow vacuum together with gripping fingers to grasp objects. The high flow vacuum is provided at an end-effector vacuum applicator of the robotic system, and the vacuum applicator is coupled to a high flow vacuum system. The end-effector includes at least one actuatable finger for gripping objects upon the application of vacuum. The gripping end-effector is attached to an arm attachment portion that is attached to an articulated arm of the robotic system.

### PRIORITY

The present application claims priority to U.S. Provisional Patent Application 63/728,967 filed December 6, 2024, the disclosure of which is hereby incorporated by reference in its entirety.

### BACKGROUND

The invention generally relates to programmable motion systems and relates in particular to end-effectors for programmable motion devices (e.g., robotic systems) for use in object processing systems such as object sortation systems.

End-effectors for robotic systems may be employed, for example, in certain applications to select and grasp an object, and then move the acquired object very quickly to a new location. End-effectors should be designed to quickly and easily select and grasp an object from a jumble of dissimilar objects, and should be designed to securely grasp an object during movement. Certain end-effectors, when used on different objects of different physical sizes, weights and materials, may have limitations regarding how securely they may grasp an acquired object, and how securely they may maintain the grasp on the object during rapid movement, particularly rapid acceleration and deceleration (both angular and linear). Further, in certain applications it may be desired to place an object at a destination in a required orientation or pose, particularly with respect to an environment such as a container being packed by a robotic system.

Many end-effectors employ vacuum pressure for acquiring and securing objects for transport and/or subsequent operations by articulated arms. Other techniques for acquiring and securing objects involve electrostatic attraction, magnetic attraction, needles for penetrating objects such as fabrics, fingers that squeeze an object, hooks that engage and lift a protruding feature of an object, and c that expand in an opening of an object, among other techniques.

In applications where vacuum pressure is used to acquire and secure objects, an end-effector on an articulated arm may include a vacuum cup having a compliant portion, e.g., a bellows portion that contacts the object to be grasped. The compliant portion may be formed of a polymeric or elastomeric material that is flexible enough to allow it to change its shape to adapt to variations in object surface structures, and to varying physical relationships between the articulated arm and the object, such as for example varying angles of approaches to objects. The flexibility further allows the vacuum cup to conform to the shape of objects or to wrap around corners of objects to create an adequate seal for acquiring and securing the object.

Other types of end-effectors including vacuum cups with less flexible compliant portions (in addition to those using electrostatic attraction, magnetic attraction, needles for penetrating objects such as fabrics, fingers that squeeze an object, hooks that engage and lift a protruding feature of an object, and collets that expand in an opening of an object), are less effective at acquiring and moving a wide variety of objects.

Such applications in which a robotic system needs to accurately process a wide variety of sizes of objects relative to an environment include, for example, packing multi-unit e-commerce orders into a container, packing a single unit into an automated bagging system, packing or consolidating containers used in an automated storage and retrieval system (AS/RS), and scanning objects in front of scanners such as barcode scanners or RFID scanners.

Vacuum end-effectors however, may be limited in their ability to acquire objects of a wide variety of sizes, such as if the objects being processed include small objects such as small sealed books, DVD’s, pencils, toys and other small objects, particularly items with widely varying aspect ratios where the automated processing system is unable to control which face of an object is presented to the programmable motion device. There are also many objects for which creating a seal is not possible or whose geometry makes it difficult to create an appropriate seal. Some such objects include, for example, strainers which have large voids, preventing the generation of a negative pressure region, and tabbed boxes where there is no convenient surface upon which to create a seal.

In pinch grasps, two or more points are pinched together to create normal forces on an object. These normal forces then generate friction to hold that object relative to the gripper. This is typically done through direct actuation of an existing mechanism, which may be for example a linear-slide or an electric motor that causes these points to pinch onto the object. Recently vacuum actuated soft systems have been provided that allow structures and bags to collapse down with rigid components integrated onto the outside of the system such that when the soft structure deforms the rigid components move allowing items to be grabbed. Such systems however, rely on closed seal bags so that the air could be fully evacuated from them.

This in turn generates a deformation used to drive a pinching motion, but such systems rely on sealing the entire air chamber.

The reliance on a sealed air chamber has two main drawbacks. First, this prevents the detection of a pressure change, which may be useful to verify that there has been a proper seal to provide a sufficiently viable grasp. Second, using a sealed membrane for actuation means that the system must rely completely on the pinching operation for the generation of forces. Any error in the operation leads to a failed grasp.

There remains a need therefore, for systems and methods for more efficiently and effectively packing and manipulating objects by efficiently acquiring objects of a wide variety of sizes without adversely impacting throughput.

### SUMMARY

In accordance with an aspect, the invention provides an object processing system with an input area where objects are presented to a programmable motion device, the programmable motion device having an end-effector attached thereto that is coupled to a vacuum source, and a perception system provides perception data regarding an object to be processed at the input area. The end-effector includes at least one finger that is actuatable to move from a first position to a second position upon the application of vacuum, in a vacuum direction, that is provided by a vacuum source. The second position of the at least one finger results in the application of a gripping force in a gripping direction that is generally transverse from the vacuum direction.

In accordance with another aspect, the invention provides a vacuum-actuated gripping end-effector with at least one finger that is actuatable to move from a first position to a second position under a vacuum force in a vacuum direction provided by a vacuum source. The second position results in the application of a gripping force in a gripping direction that is generally transverse to the vacuum direction.

In yet another aspect of the invention, a method of processing objects using an end-effector of a programmable motion device that receives objects in an input area that is proximate to the programmable motion device with a perception system that provides perception data regarding an object to be processed in the input area. At least one finger of the end-effector is actuated under a vacuum force in a vacuum direction provided by a vacuum source where the actuated finger applies a gripping force on the object in a gripping direction that is generally transverse to the vacuum direction.

### BRIEF DESCRIPTION OF THE DRAWINGS

The following description may be further understood with reference to the accompanying drawings in which:

FIG. 1 shows an illustrative diagrammatic view of an object processing system including a programmable motion device with an end-effector system in accordance with an aspect of the present invention;

FIG. 2 shows an illustrative diagrammatic top view of the object processing system of FIG. 1;

FIG. 3 shows an illustrative diagrammatic enlarged view of the programmable motion device of the object processing system of FIG. 1;

FIG. 4 shows an illustrative diagrammatic further enlarged view of the end-effector of the programmable motion device of FIG. 1;

FIG. 5 shows an illustrative diagrammatic view of the input area of the object processing system of FIG. 1;

FIG. 6 shows an illustrative diagrammatic view of the end-effector of the system of FIG. 1 engaging an object being processed at the input area;

FIGS. 7A and 7B show illustrative diagrammatic views of the end-effector in the object processing system of FIG. 1 without its shroud, shown in the open position (FIG. 7A) and the closed position (FIG. 7B);

FIGS. 8A and 8B show illustrative diagrammatic views of the end-effector of FIGS. 7A and 7B with a portion of the housing removed, shown in the open position (FIG. 8A) and the closed position (FIG. 8B);

FIGS. 9A - 9D shows illustrative diagrammatic views of an end-effector coupling system for use in the object processing system of FIG. 1 in accordance with an aspect of the present invention, showing a spring-loaded pin on an end-effector attachment portion and an aperture on the end-effector (FIG. 9A), showing the pin proximate the end-effector (FIG. 9B), showing the end-effector attachment portion rotated with respect to the end-effector (FIG. 9C), and showing the pin of the end-effector attachment portion engaging the aperture of the end-effector (FIG. 9D);

FIG. 10 depicts an illustrative diagrammatic exploded view of an end-effector coupling system for use in the object processing system of FIG. 1 in accordance with another aspect of the present invention, showing an alignment feature in the end-effector and an alignment recess in the end-effector attachment portion;

FIGS. 11A and 11B show illustrative diagrammatic views of an end-effector coupling system in accordance with a further aspect of the invention, showing sets of magnets on each of the end-effector attachment portion and the end-effector (FIG. 11A) and showing the end-effector rotated and attached to the end-effector attachment portion (FIG. 11B);

FIGS. 12A and 12B show an illustrative diagrammatic underside views of an end-effector in accordance with an aspect of the invention with the shroud not attached to the fingers and with the fingers in an open position (FIG. 12A) and with the shroud removed for clarity (FIG. 12B);

FIG. 13 shows an illustrative diagrammatic underside view of the end-effector of FIGS. 12A and 12B with the fingers in a closed position;

FIG. 14 shows an illustrative diagrammatic underside view of an end-effector in accordance with another aspect of the invention with the shroud attached to the fingers and with the fingers in a closed position;

FIG. 15 shows an illustrative diagrammatic side elevational view of the end-effector of FIG. 14;

FIG. 16 shows an illustrative diagrammatic view of a portion of an end-effector in accordance with another aspect of the invention (shown without the shroud) that includes apertures in the fingers;

FIG. 17 shows an illustrative diagrammatic enlarged view of a portion of a finger of the end-effector of FIG. 16;

FIG. 18 shows an illustrative diagrammatic underside view of the end-effector of FIG. 16 (with the shroud) in an open position;

FIG. 19 shows an illustrative diagrammatic underside view of the end-effector of FIG. 16 (with the shroud) in a closed position;

FIG. 20 shows an illustrative diagrammatic enlarged view of an end-effector in accordance with an aspect of the invention (shown without the shroud) that includes surface features for enhancing friction;

FIG. 21 shows an illustrative diagrammatic view of a portion of an end-effector in accordance with a further aspect of the invention (shown without the shroud) that includes apertures in the fingers and surface features for enhancing friction;

FIG. 22 shows an illustrative diagrammatic underside view of an end-effector in accordance with an aspect of the invention that includes a single finger and with the shroud not attached to the finger;

FIG. 23 shows an illustrative diagrammatic exploded view of an end-effector in accordance with another aspect of the invention (shown without the shroud) that includes shorter fingers;

FIG. 24 shows an illustrative diagrammatic exploded view of an end-effector in accordance with another aspect of the invention (shown without the shroud) that includes longer fingers;

FIG. 25 shows an illustrative diagrammatic view of an end-effector in accordance with another aspect of the invention that includes fingers with multiple sloped surfaces;

FIG. 26 shows an illustrative diagrammatic exploded view of an end-effector in accordance with another aspect of the invention that includes three fingers;

FIG. 27 shows an illustrative diagrammatic exploded view of an end-effector in accordance with another aspect of the invention that includes four fingers;

FIG. 28 shows an illustrative diagrammatic exploded view of an end-effector (without the shroud) that includes pin mounting structures for attaching the fingers to the housing;

FIG. 29 shows an illustrative diagrammatic view of the end-effector (without the shroud) of FIG. 28 showing the fingers attached to the housing;

FIG. 30 shows an illustrative diagrammatic enlarged view of a portion of the end-effector of FIG. 29 shown including a spring;

FIG. 31 shows an illustrative diagrammatic view of an end-effector in accordance with a further aspect of the invention in which the fingers includes vacuum actuatable metal spring plates;

FIG. 32 shows an illustrative diagrammatic view of the end-effector of FIG. 31 with the end-effector in the closed position with a portion of the housing removed; and

FIG. 33 shows an illustrative diagrammatic view of the end-effector of FIG. 31 with the end-effector in the open position with a portion of the housing removed.

The drawings are shown for illustrative purposes.

### DETAILED DESCRIPTION

In accordance with various aspects, the invention provides an end-effector system for programmable motion devices (e.g., robotic systems) that provides high flow vacuum together with gripping fingers to grasp objects. The high flow vacuum is provided at an end-effector vacuum applicator of the robotic system, and the vacuum applicator is coupled to a high flow vacuum system. The vacuum applicator is attached to a cup attachment portion, which is in turn attached to an arm attachment portion that is attached to an articulated arm of the robotic system.

Object processing systems in accordance with various aspects of the invention employ any of a variety of high flow vacuum end-effectors that are used for different objects during object processing as discussed herein. A challenge with using high flow vacuum is that if the vacuum cup contact surface contacts plural objects, the plural objects may all be grasped because the high flow vacuum system does not require that the vacuum cup tightly seal a closed surface of the object being grasped. Using a vacuum cup therefore that contacts plural objects may well grasp all of the plural objects using the high flow vacuum.

Applicants have discovered that a vacuum cup may be provided that relies on open channels and membranes to provide actuation and sensing in antipodal grasps. End- effectors of various aspects of the invention include fingers that are actuated by the vacuum. A consideration is that the fingers of the vacuum powered pinch gripper must be simultaneously stiff enough to able downward forces to wedge apart objects and find between objects while being compliant enough to be activated by the vacuum system. These needs are fundamentally at odds with each other in standard designs. End-effectors of various aspects of the invention improve manufacturability and robustness, yet achieve the following important design considerations. The end-effectors generate pinch grasps using vacuum actuation, may be integrated into a cup swap system with standard suction cups, and they use open air channels in the actuation stream. The open air channels may be used for sensing grips and may be used to grasp should an pinch grasp fail. Further, the fingers are sufficiently compliant for actuation yet sufficiently stiff for wedging between objects.

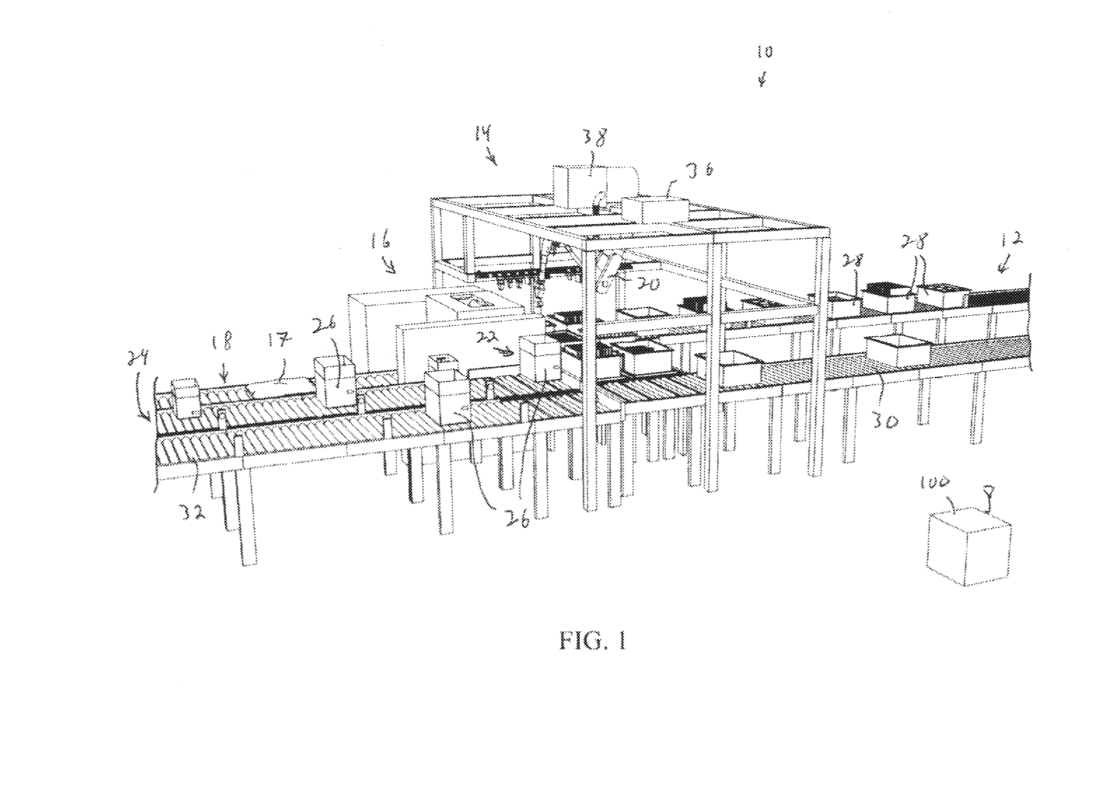

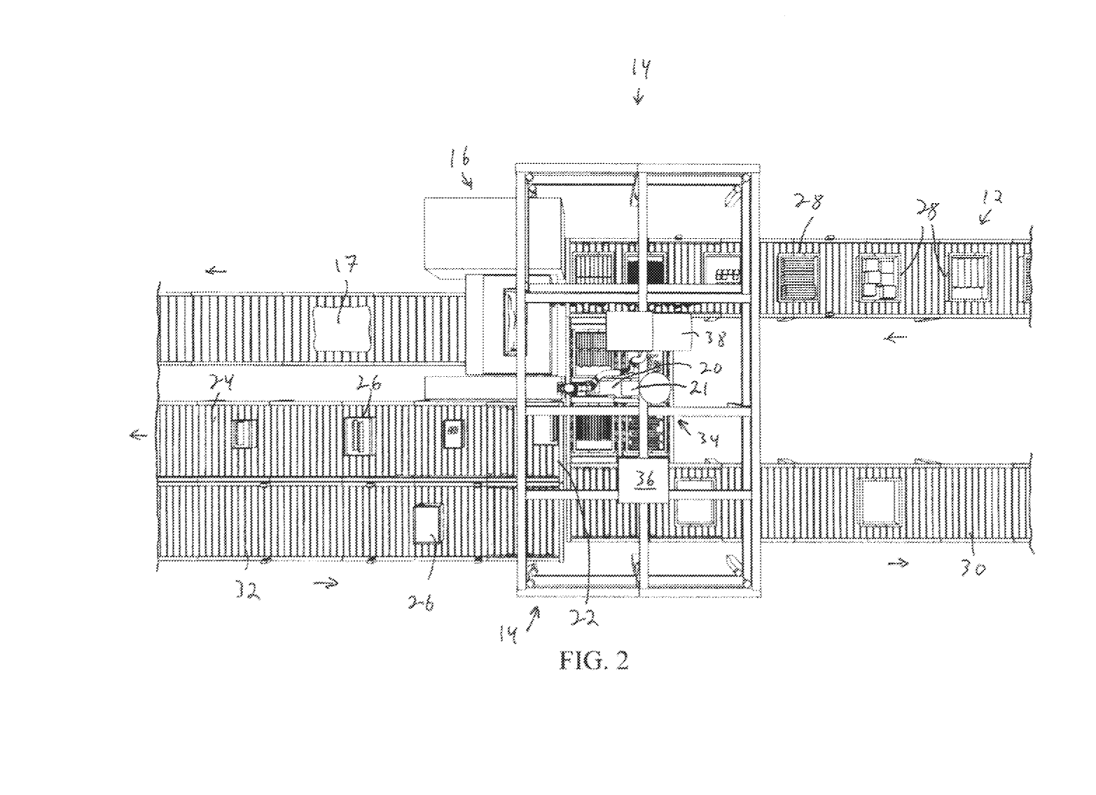

FIG. 1 shows an object processing system 10 in accordance with an aspect of the present invention that includes an input source conveyor 12 that provides objects to be processed to a processing station 14 that includes a programmable motion device 20. The programmable motion device 20 is used to grasp and move objects received at an input area 34 (shown in FIG. 2) from the input source conveyor 12, and to provide objects to any of an auto-bagging system 16 that provides objects in sealed bags 17 along an auto-bagging system conveyor 18, or to provide objects to output containers 26 (e.g., shipping boxes) provided at a packing area 22 on an container output conveyor 24. The objects to be processed may be provided in input source containers 28.

With further reference to FIG. 2, a top view shows the input source conveyor 12 that brings input objects (e.g., in bins 28) to the input area 34. The input area 34 include two conveyor sections that receive objects from the input source conveyor 12, and both conveyor sections lead to a source container return conveyor 30 as shown in FIG. 2. Empty output containers 26 are provided along an empty output container conveyor 32 to the processing station 14, and are routed to the packing area 22 where they are packed prior to being moved along the container output conveyor 24. Operation of the conveyors and other components of the system is provided by the one or more computer processing systems 100 as discussed herein, and the programmable motion device may include its own processing control system 36 in communication with the one or more computer processing systems 100.

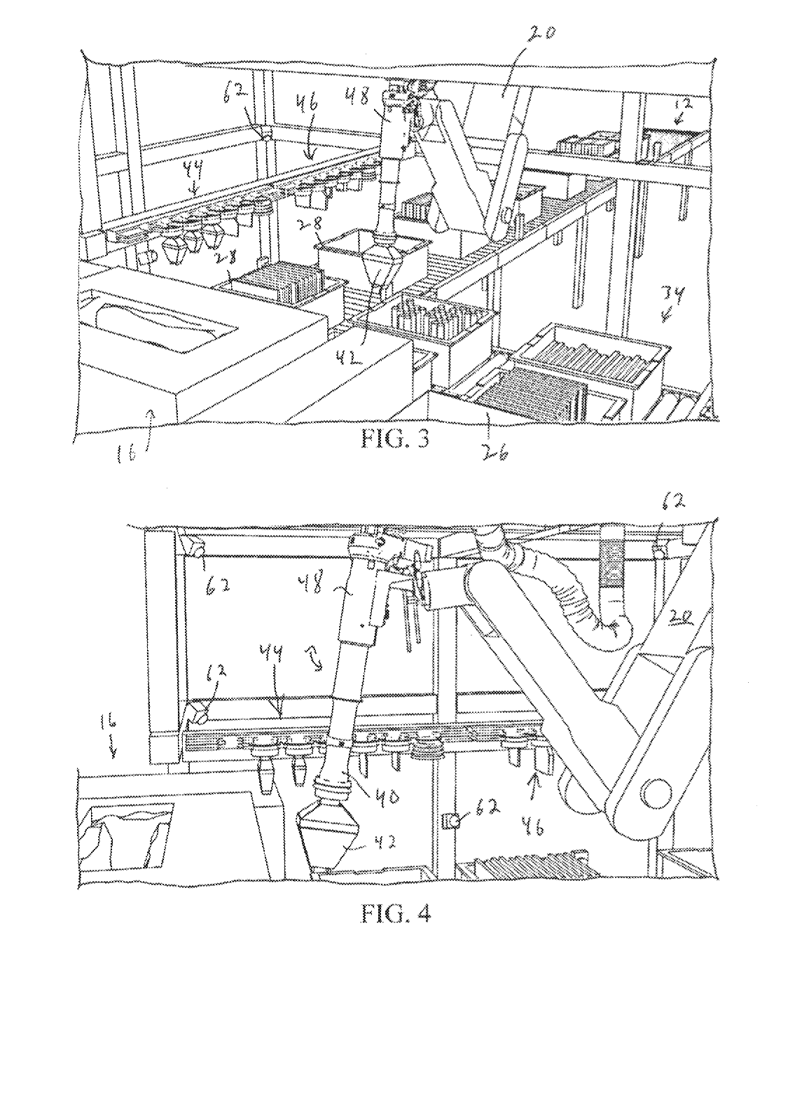

With reference again to FIG. 1, the programmable motion device 20 includes an end-effector attachment portion (shown in more detail in FIG. 4) that is coupled to a high flow vacuum source 38, such as for example, a side-channel blower, air amplifiers or multistage ejectors. The high flow vacuum source 38 may, for example, provide at the end-effector attachment portion 40 an air flow of at least about 100cubic feet per minute, and a vacuum pressure of no more than about 100,000 Pascals below atmospheric, or no more than about 85,000 Pascals below atmospheric, or no more than about 65,000 Pascals below atmospheric. Again, the use of such a high flow vacuum source, while providing benefits in grasping objects where a seal is not tightly formed between the vacuum cup and the object, presents challenges in grasping only one object among a plurality of objects.

With reference to FIG. 3, an end-effector 42 may be attached to the end-effector attachment portion 40 of the programmable motion device. Plural additional end-effectors may be provided on one or more end-effector racks 44, 46 as further shown in FIG. 4. The programmable motion device is programmed to be able to engage and disengage any of the end-effectors on the racks 44, 46 as further discussed below. The end-effector attachment portion 40 is mounted within a collar 48 that is attached to the programmable motion device 20, and an opposite end of the end-effector attachment portion (that extends out the other side of the collar 48) is coupled to a vacuum hose 50 that is coupled to the vacuum source 38.

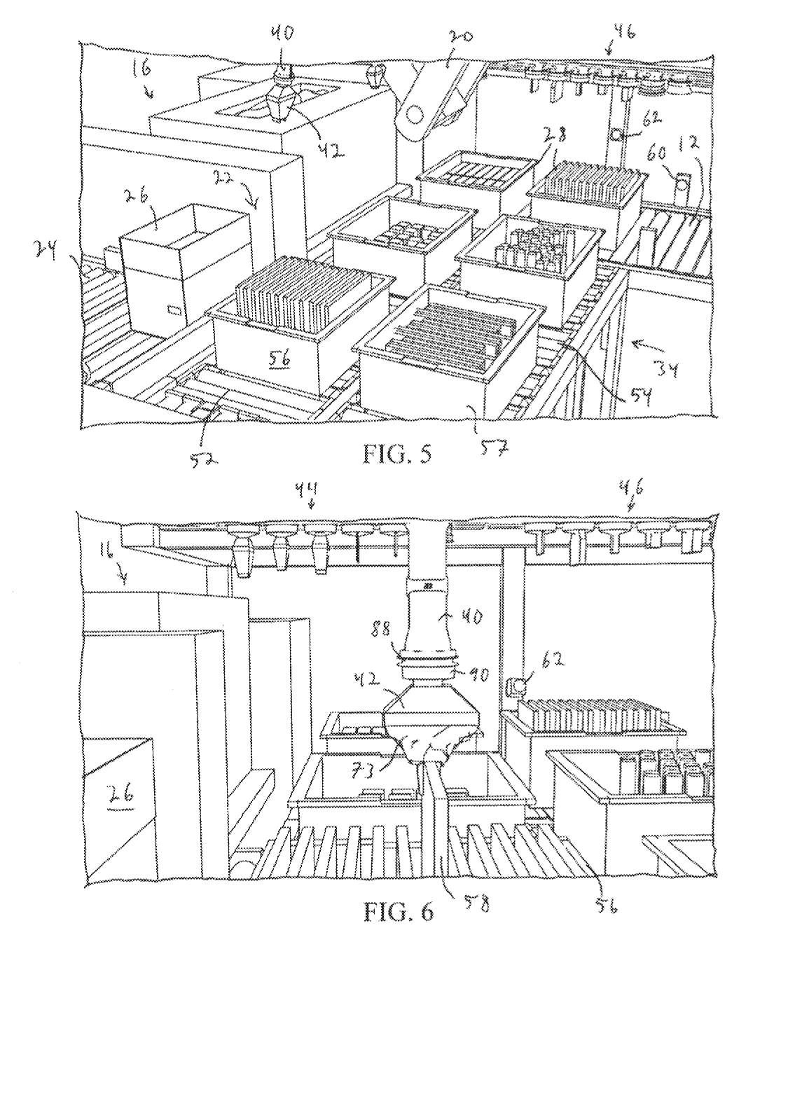

As shown in FIG. 5, exemplary objects to be processed by the system may come in a variety of sizes with a variety of exposed face sizes available for grasping. The input area 34 in FIG. 5 includes the two conveyor sections 52, 54, both of which may be accessed by the end-effector of the programmable motion device. In certain applications, each conveyor section may further include right-angle-transfer mechanisms (e.g., raisable belts) to move containers 56, 57 between the conveyor sections 52, 54. An input container, (e.g., container 56) may include objects with a large aspect ratio but with small-sized faces exposed to the programmable motion device. In accordance with an aspect of the present invention, the system may select an end-effector (e.g., 42) to be used to grasp an object 58 from the input container 56 as shown in FIG. 6. A perception system (e.g., including perception units 62 and perception unit 21 shown in FIG. 2) provide perception data regarding an object to be processed that is in the input area, and the perception data includes data that is representative of an exposed face of the object. The system may include conveyor perception units 60 along the input source conveyor 12 as well as the perception units 62 on the support structure from which the programmable motion device is suspended for aiding (together with the computer processing systems 36, 100) in operation of the programmable motion device of grasping, moving and placing objects into any of, for example, output containers 26 or sealed bags 17 as discussed herein.

The end-effector includes one or more fingers, a housing and a deformable shroud. The fingers are inside of the shroud and are attached to the housing. The housing attaches to a vacuum source. When vacuum is generated in a vacuum direction (e.g., upward through the attachment portion 40 as shown in FIG. 6) a pressure differential across the shroud is created. This causes the fingers to pinch inwards and close in a gripping direction that is generally transverse to the vacuum direction. The pressure on the side of the finger generates a torque around the connection to the housing. Additional forces on the fingers are generated by the deformable shroud which pulls the fingers inwards. This is caused by the deformation the shroud experienced from the pressure across gaps between the fingers. These forces move the finger to contact an object. The force the fingers apply to the object are normal to the surface of the object (normal forces). The fingers may have friction enhancing material that increases the coefficient of friction between the object and the fingers. The normal force and coefficient of friction generate the frictional forces between the object and grippers. These frictional and normal forces determine the weight and accelerations that the gripper may apply.

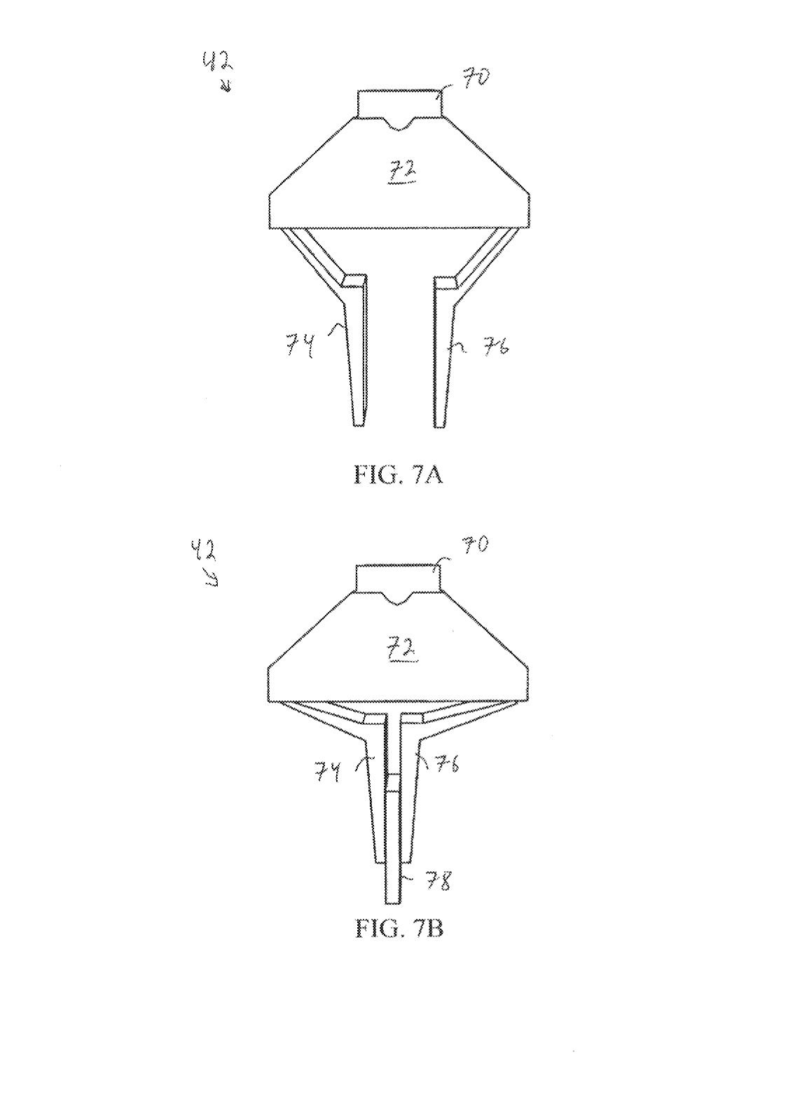

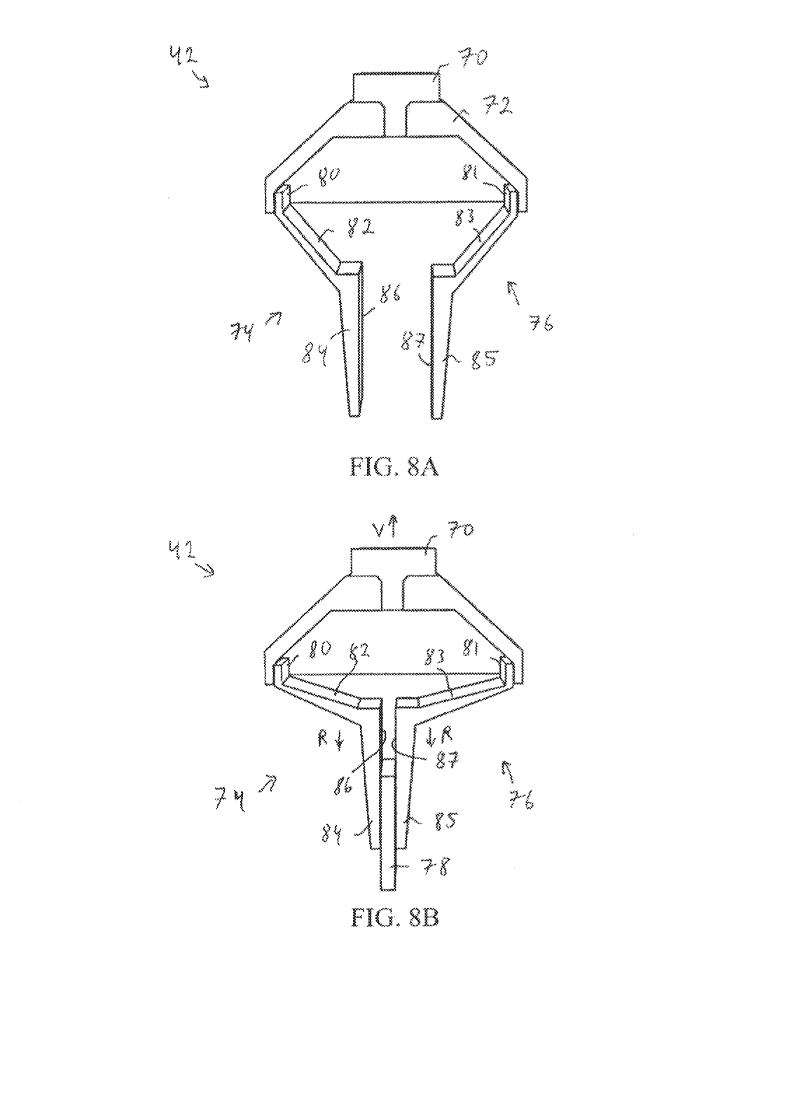

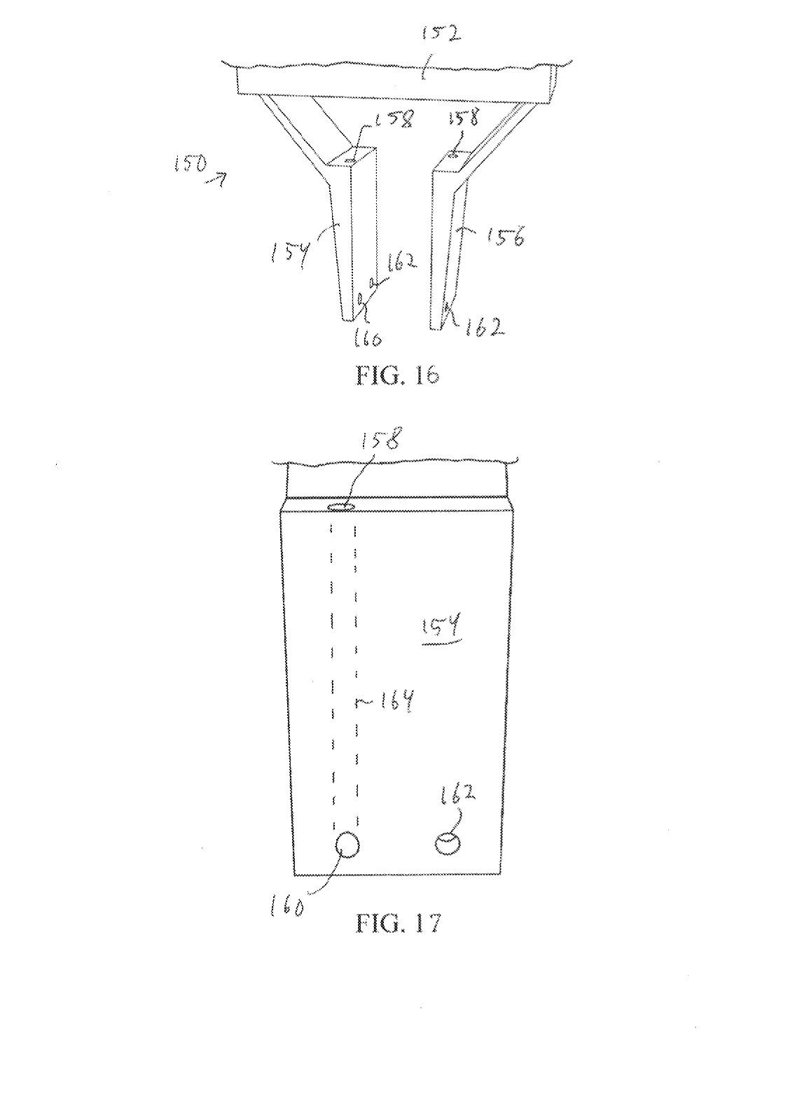

FIG. 7A shows a portion of the end-effector 42 without the outer surrounding shroud 73 (shown in FIG. 6), including a vacuum port 70, a housing 72, and fingers 74, 76. The proximal end of each finger 74, 76 is attached to an inner wall within the housing (shown in FIG. 16). Each finger 74, 76 is formed of a flexible material (e.g., a polymeric or elastomeric material) such that under the force of the high flow vacuum (when surrounded by a shroud) each finger 74, 76 is drawn up toward the housing 72, and in doing so, the fingers 74,76 move closer together to grasp an object 78, as shown in FIG. 7B. FIGS. 8A and 8B show movement of the fingers with a portion of the housing removed for clarity. The fingers 74, 76 of the end-effector 42 are shown open in FIG. 8A and closed in FIG. 8B. The finger 74 includes an attached portion 80 that is attached to an inner wall of the housing, a middle portion 82, and a distal portion 84 that includes a grasping face 86. Similarly, the finger 76 includes an attached portion 81 that is attached to an inner wall of the housing, a middle portion 83, and a distal portion 85 that includes a grasping face 87. The pinching of the fingers 74, 76 is therefore caused by the vacuum force (V) overcoming the resistive forces (R) of the fingers, which are provided primarily by the middle portions 82, 83 and the interfaces between the middle portions 82, 83 and the respective attached portions and the distal portions.

As shown in FIG. 6, each end-effector includes an annular mounting ring 88 for engagement with the rack structures 64 and for engagement with end-effector attachment portion 40 of the programmable motion device 20. Each end-effector also includes a coupling cover 90 that is attached to each annular mounting ring 88 as well as to each vacuum port. The coupling of each end-effector to the end-effector attachment portion may be provided, for example, by engaging magnets on one part with a ferromagnetic metal (or complementary magnets) of the other part. Because the one or more fingers are fixed to a location within the housing, the system needs to engage each end-effector at an orientation that is known.

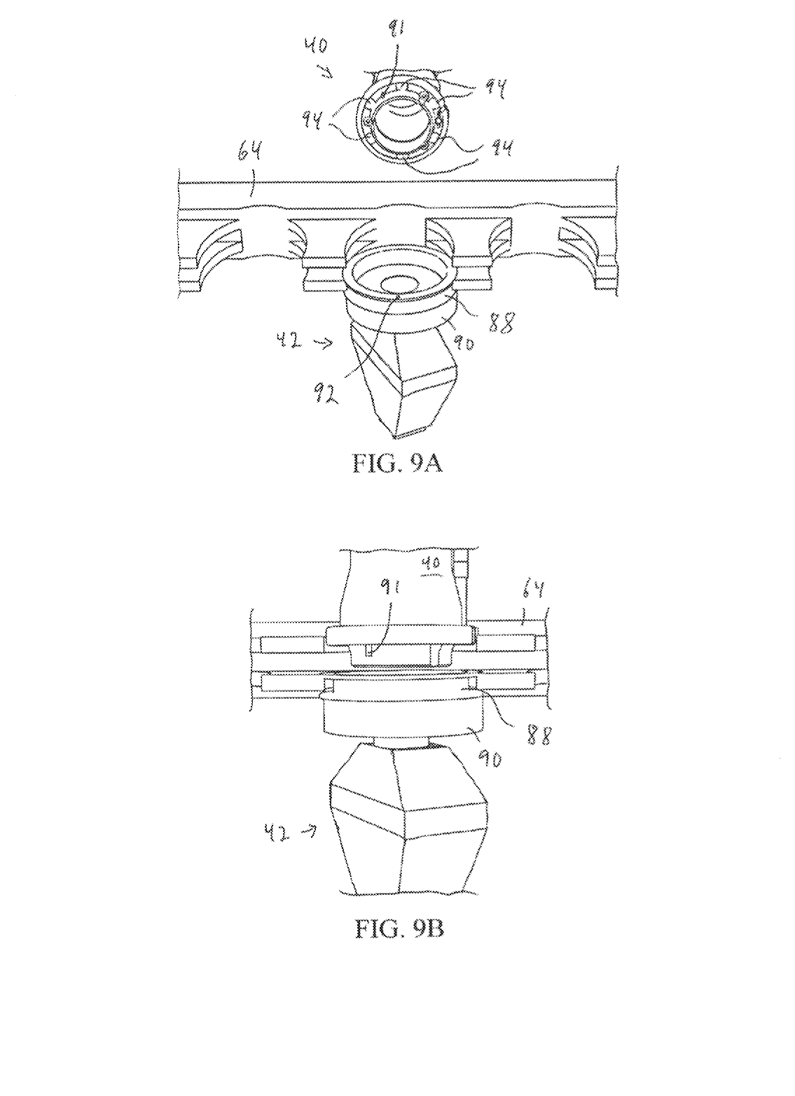

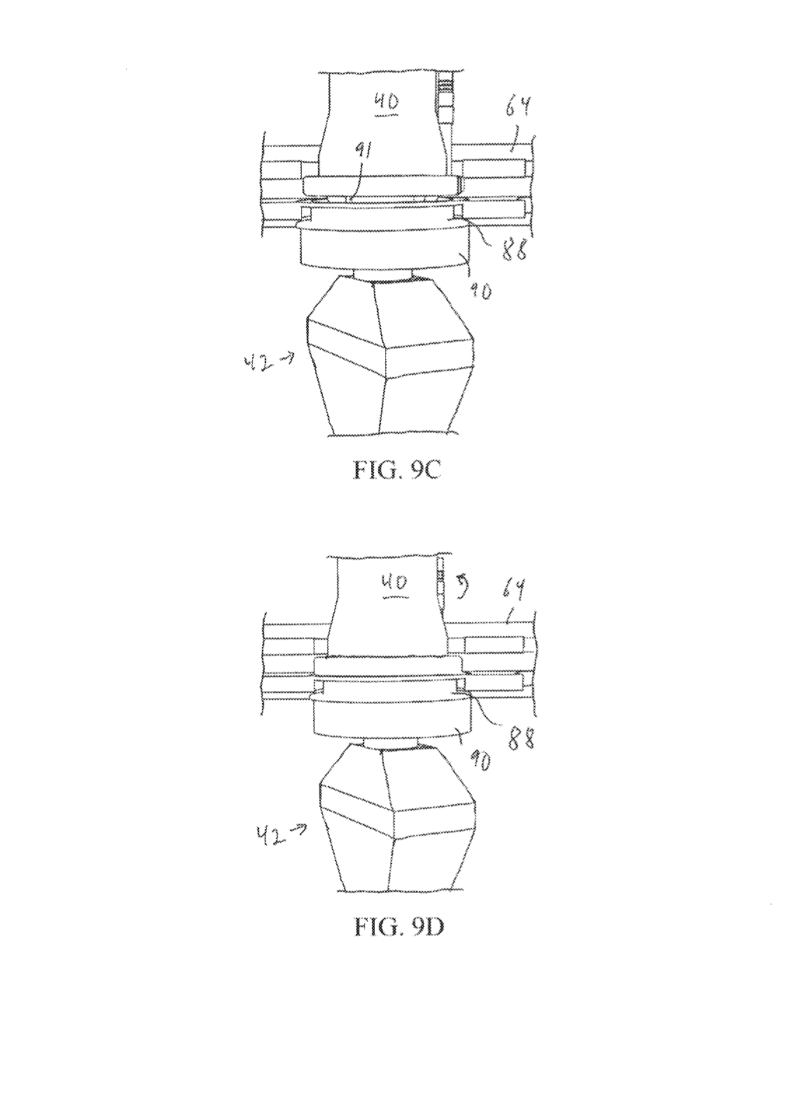

FIGS. 9A - 9D for example, show an engagement system that includes a pin and a pin recess for alignment of the end-effector on the attachment portion. With reference to FIG. 9A, a spring-loaded pin 91 is provided on the attachment portion, and a pin recess 92 is provided on the annular mounting ring 88. During use in attaching the end-effector, the programmable motion device positions the attachment portion 40 above the end-effector on the rack, wherein the pin 91 and the recess 92 are not yet aligned (FIG. 9B). The attachment portion is lowered further, and the pin contacts the annular mounting ring 88 (FIG. 9C). The end-effector attachment portion is then rotated until the pin 91 engages the pin recess 92 (FIG. 9D). The retracted position of the pin 91 (shown in FIG. 9C) is designed such that the magnetic fields of the magnets 94 are not yet so strong as to inhibit rotation of the attachment portion with respect to the end-effector. In accordance with further aspects, the magnets 94 may be provided as electromagnets that may be engaged only when the pin has been received within the pin recess (FIG. 9D). In this example, the attachment portion rotates until it is aligned with the end-effector on the rack.

In accordance with another aspect, alignment of the coupling of each end-effector 42 to the end-effector attachment portion 40 is provided by an alignment feature 191 that engages with an alignment recess 192 provided in the end-effector attachment portion when rotationally aligned, as depicted in an exploded view as shown in FIG. 10. The alignment feature 191 may be provided on an insert 194 that is captured within the end-effector 142 with the annular mounting ring 188 that is threaded into a threaded receptacle of the end-effector 142. An o-ring 198 may be provided to minimize vacuum leakage through the threads of the threaded annular mounting ring 188 and the end-effector 142. Furthermore, a mesh screen insert 196 may be optionally provided to minimize the potential for introducing debris into the vacuum system during operation. During use in attaching the end-effector 142 to the attachment portion 40, the programmable motion device positions the attachment portion 40 above the desired end-effector on the rack, without a priori knowledge of the orientation of the desired end effector in the rack. The attachment portion 40 is lowered, and if the alignment is not established, the alignment feature 191 fails to engage in the alignment recess 192, causing resistance to movement. The programmable motion device then rotates the attachment portion 40 until the resistance is minimized, where the alignment feature 191 engages into the alignment recess 192 causing the magnets 94 (described above) to provide the attachment force attaching the end-effector 142 to the attachment portion 40.

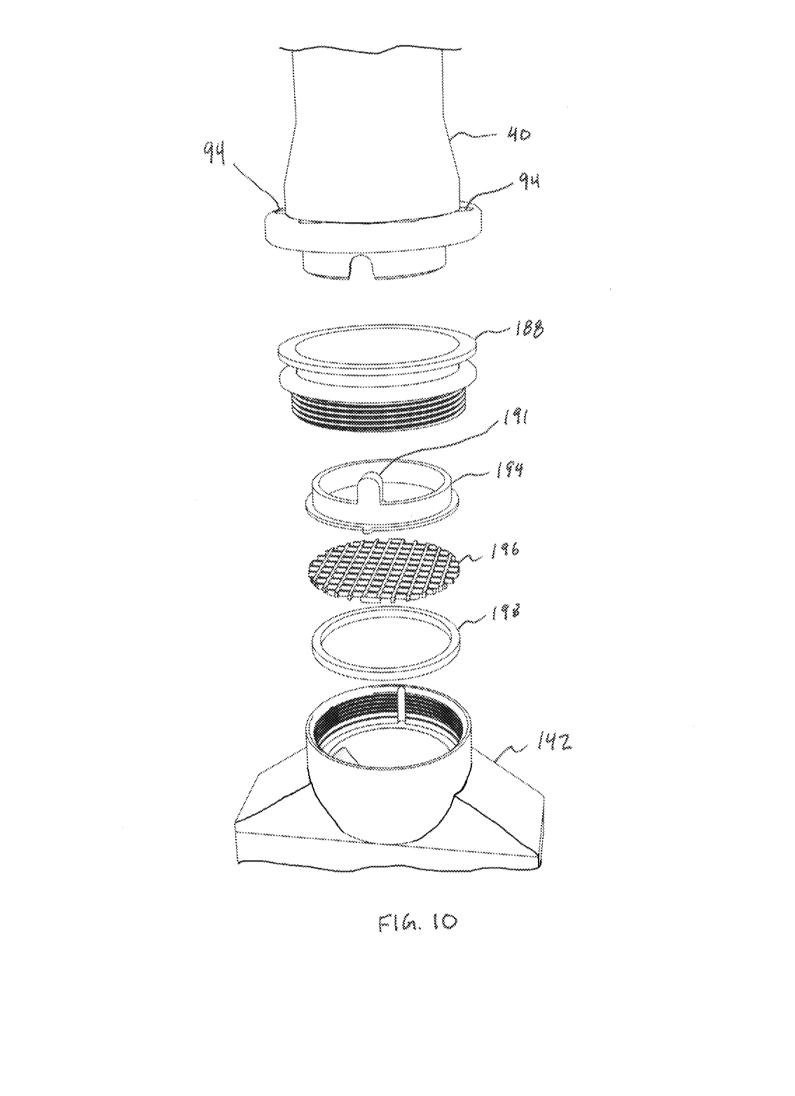

In accordance with further aspects, the magnets used for engaging the attachment portion to the annular attachment ring of the end-effector may themselves effect proper alignment of the end-effector with the attachment portion. FIGS. 11A and 11B, for example, show another attachment portion 40’ that includes s-magnets 94 and n-magnets 96, while the end-effector 42’ includes n-magnets 95 and s-magnets 97. FIG. 11A shows the magnets, and FIG. 11B shows the attachment portion 40’ coupled to the end-effector 42’, showing that the end-effector 42’ has been rotated under the polar forces of the magnets to both align with and engage the end-effector 42’ with the attachment portion 40’. The np-magnets align with the s-magnets, so irrespective of the original orientation of the end-effector with respect to the attachment portion, the parts will come together in one of either of two mutual orientations that are 180º apart; either of these mutual orientations works because the end-effectors are symmetric. In accordance with further aspects, sets of magnets may be used that couple only in a single respective orientation of each end-effector and the attachment portion. In accordance with certain aspects, the attachment portion 40’ may also (or instead) be rotated to the alignment position. In each of the systems of FIGS. 9A - 11B, the control system may know or confirm the identity of each end-effector either by a scanner or camera system that detects a code on each end-effector or by providing low level magnets that detect low level distinct field patterns identifying each end-effector.

In accordance with certain aspects of the invention, the shroud is not bonded to the fingers and has an opening that both fingers pass through. This system has two key advantages. Firstly, the system may be rapidly separated into components. The fingers may be easily removed and changed. A second advantage is that this allows the fingers to move independently and still grab if a finger is edged out of the way. The opening acts as a suction surface if only one finger contacts the box and the other is displaced into the shroud by the contact forces.

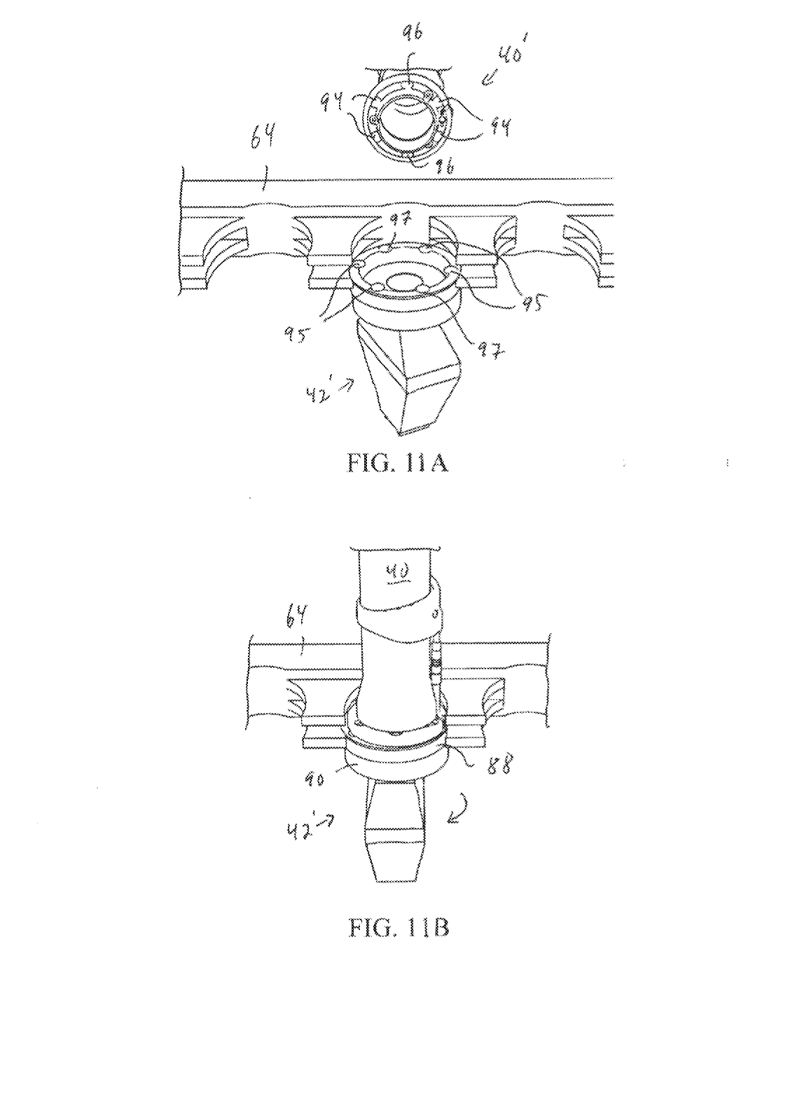

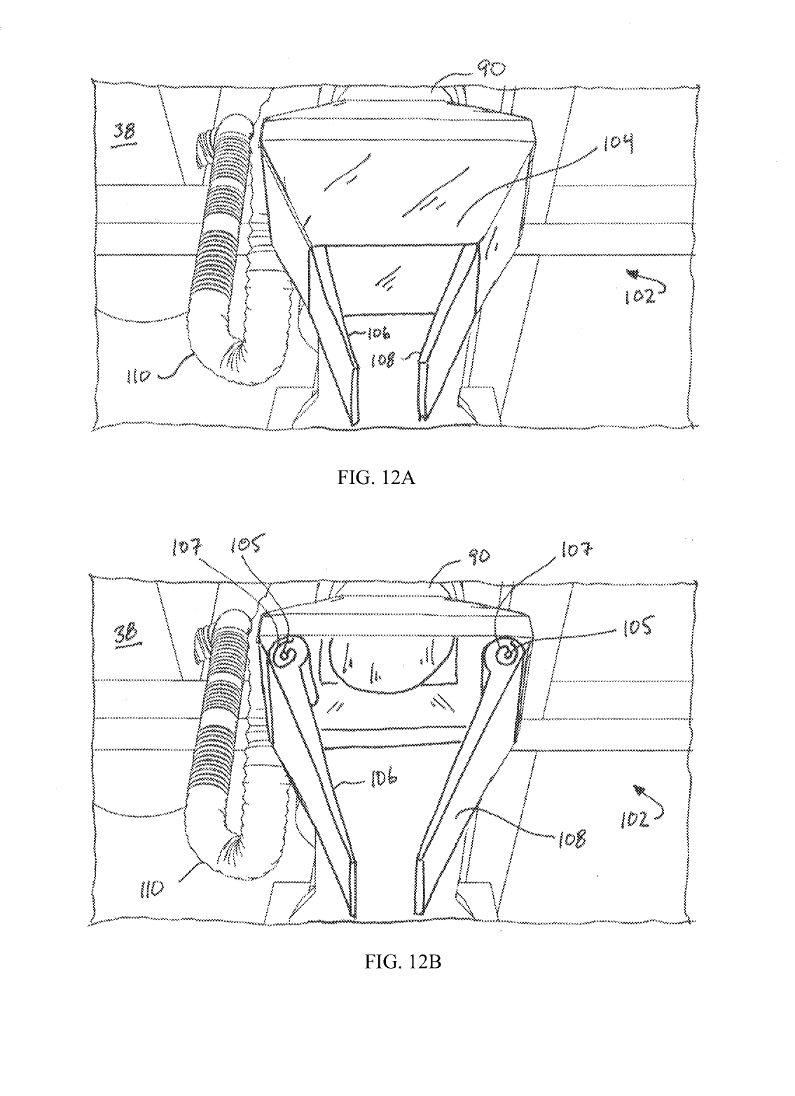

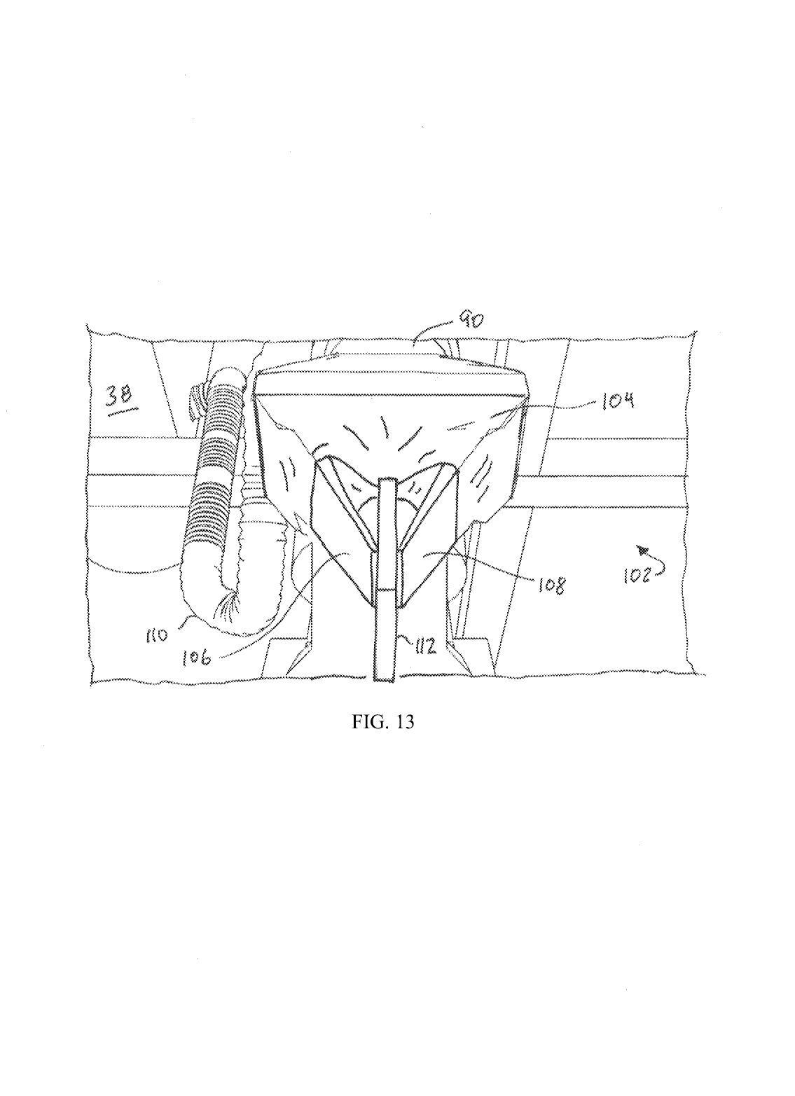

FIGS. 12A, 12B, and 13 show an end-effector 102 in accordance with an aspect of the invention that includes a shroud 104 and fingers 106, 108. The end-effector 102 is coupled to the vacuum source 38 via a large diameter hose 110, which provides the vacuum force at the opening of the shroud 104. FIG. 12A shows the end-effector with no vacuum applied, and FIG. 13 shows the end-effector with vacuum applied. FIG. 12B shows the end-effector 102 of FIG. 12A but with the shroud removed for clarity. Each of the fingers 106 and 108 rotate about pivot 105 with a spring mechanism 107 (shown as a clockspring) that biases the fingers 106 and 108 in the open position. As shown in FIG. 13, when vacuum is applied, the shroud 104 is drawn proximally (toward the coupling cover 90) and the fingers 106, 108 are also drawn proximally causing them to move toward one another to grasp the object 112. Note that the opening of the shroud 104 remains open when the vacuum is applied, acting as a high flow vacuum source that facilitates holding the object 112. This allows the fingers to move independently and still grab if a finger is edged out of the way. The shroud allows the negative pressure region to form between the fingers and both moves the fingers from the side by generating a torque and pulls on the finger using deformation of the shroud.

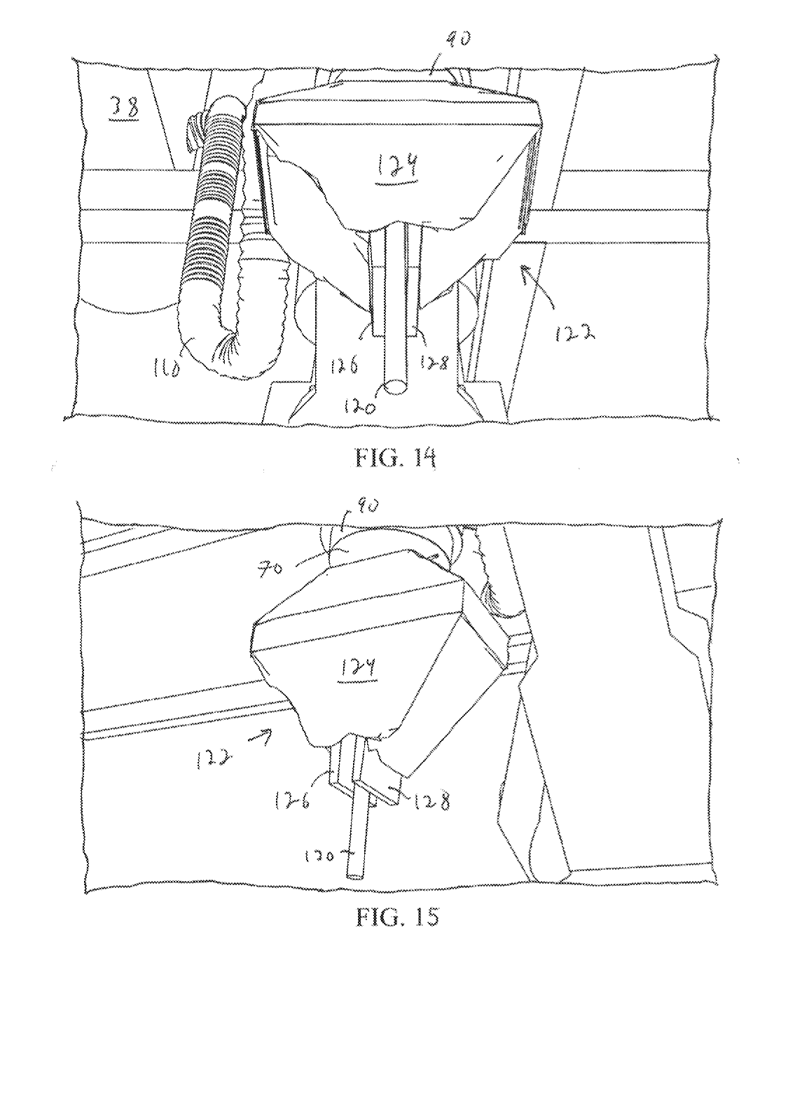

In accordance with other aspects of the invention, end-effectors may apply substantially more vacuum force between the fingers (and more pinching force of the fingers) by having the shroud attached to the fingers. FIGS. 14 and 15 show an end-effector 122 that includes a shroud 124 that is attached to fingers 126, 128. When the vacuum force is applied, the fingers 126, 128 grasp an object 120 (as shown in FIG. 14) but the object does not fully occlude the shroud opening (as shown in FIG. 15) permitting the high flow vacuum to assist in maintaining the grasp of the object 120. Such a system may be most suitable for applications in which the objects include a dimension much smaller than the opening provided by fingers.

In accordance with further aspects, the fingers themselves may include air channels through the fingers as well as a sealed deformable shroud around the fingers. In this configuration, the fingers have channels running from the interior of the shroud to their tips. These air channels only seal when the gripper successfully grasps an item, completing an air chamber and signaling a pressure drop. This mechanism may increase the normal force on the gripped objects, thereby enhancing the holding force and ensuring a more secure grip.

FIG. 16, for example, shows a portion of an end-effector 150 that includes a housing 152 and two fingers 154, 156, each of which includes channels. The shroud is not shown in FIG. 16 for clarity. With further reference to FIG. 17, one venting channel 162 provides a through-hole to the back side of the finger (to atmosphere), and the vacuum channel 164 extends (via a right-angle turn) from the aperture 158 to the aperture 160. The aperture 158 is in communication with the vacuum within the shroud when an object is being grasped, and this vacuum is provided on the object at the aperture 160 during grasping.

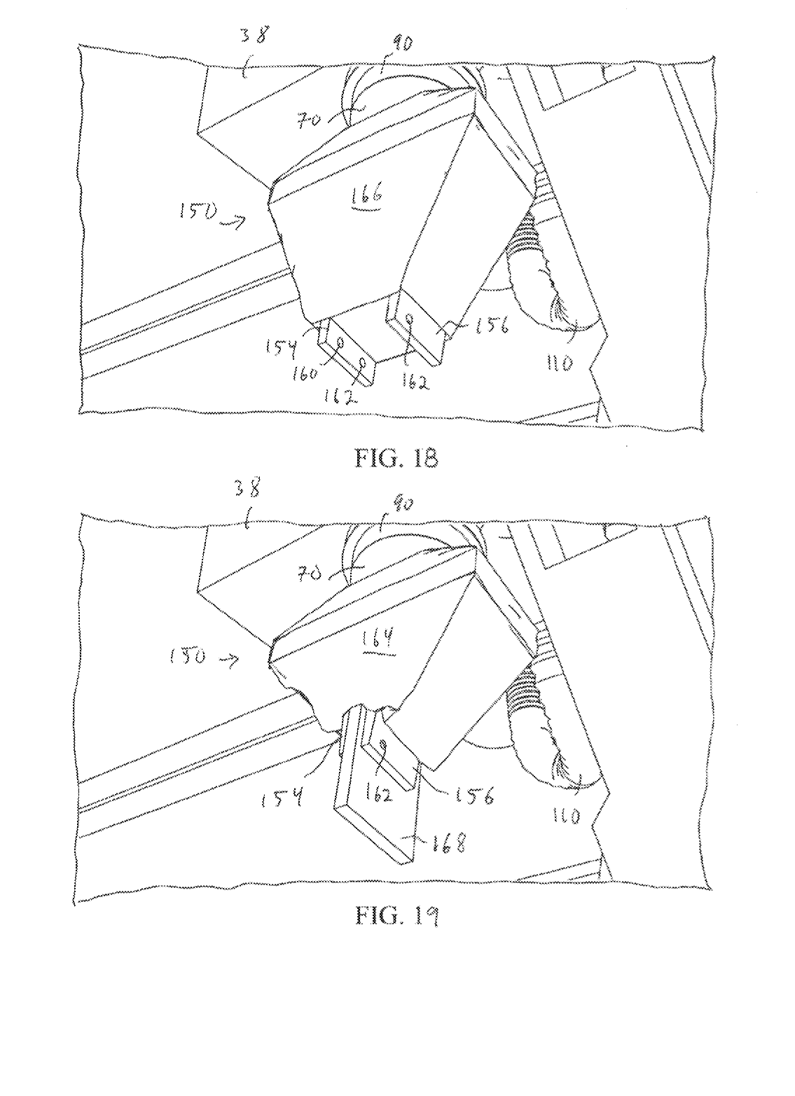

FIG. 18 shows the end-effector 150 in the open position, showing the fingers 154, 156 in the opening of the shroud 166. With reference to FIG. 19, when vacuum is applied, the fingers 154, 156 press against a grasped object 168. The vacuum provided via the channels 164 provide additional grasping for against the object 168. When the vacuum is ceased and the fingers begin to move apart from one another, the channels 162 permit atmospheric air to quickly enter the region to release the vacuum. The deformable shroud is sealed against the fingers, and the fingers therefore have channels between the interior of the shroud and the tips of the fingers. The air channels only seal when the object is successfully grabbed. This completes the air chamber and provides a signal of a pressure drop when grasped.

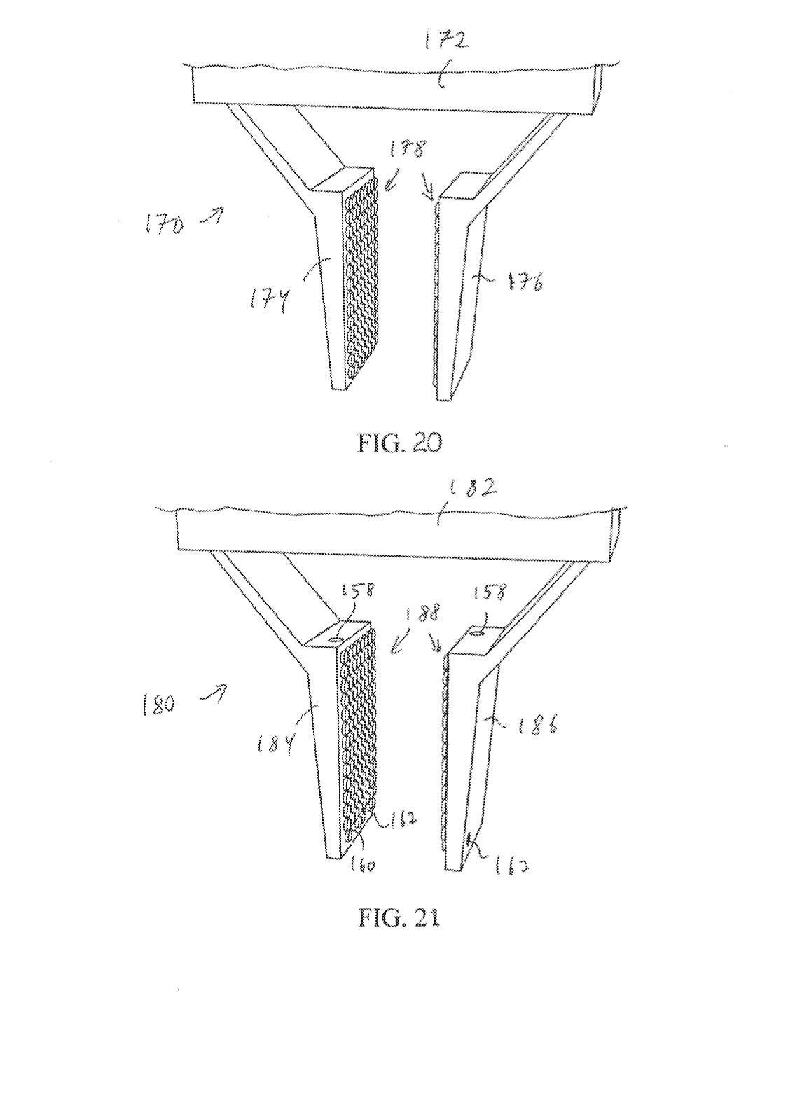

In accordance with various further aspects, the fingers may include friction enhancing surfaces to set the coefficient of friction between the object and the fingers. For example, FIG. 20 shows a portion of an end-effector 170 that includes a housing 172 and two fingers 174, 176 as discussed above. Each finger 174, 176 may include a friction enhancing surface 178 that includes, for example, a plurality of small discs of polymeric or elastomeric material. FIG. 21 shows a portion of an end-effector 180 that includes a housing 182 and two fingers 184, 186 as discussed above. Each finger 184, 186 may include a friction enhancing surface 188 that includes, for example, a plurality of small discs of polymeric or elastomeric material as well as the apertures 158, 160 and channels 162, 164 discussed above with reference to FIGS. 16-19.

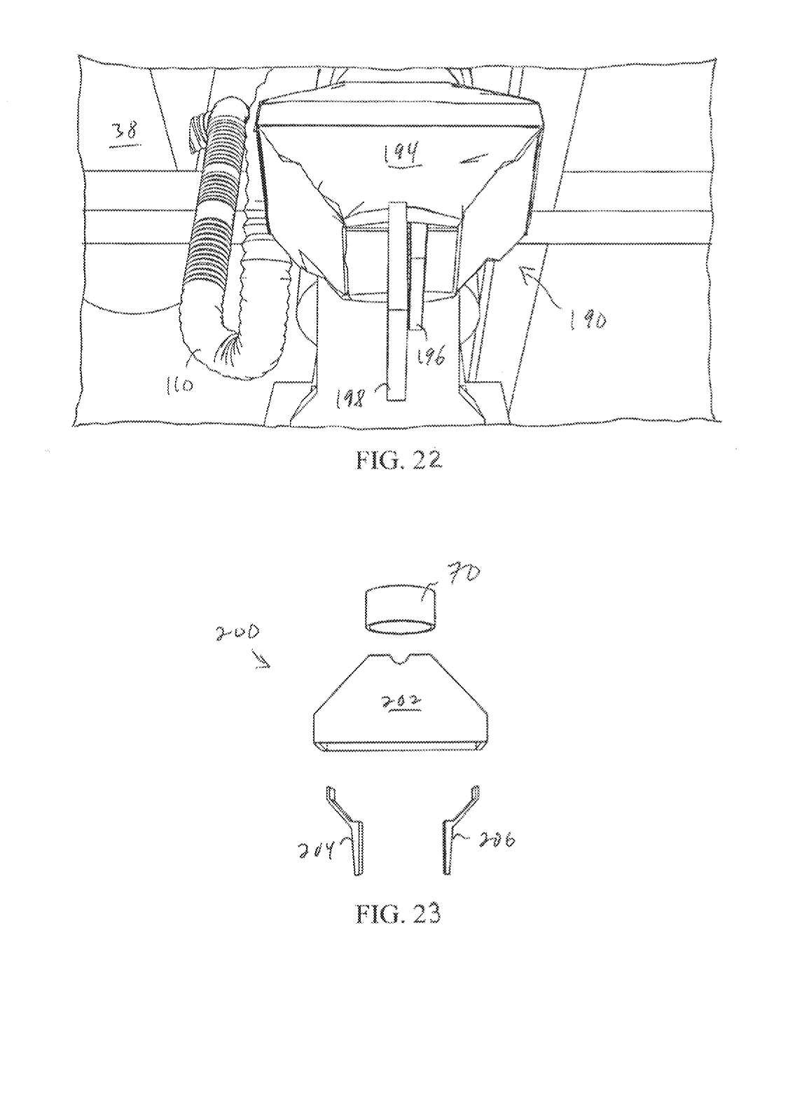

In accordance with an aspect of the invention, a single finger may be used in combination with the high vacuum source to grasp an object. FIG. 22 shows an underside view of an end-effector 190 that includes shroud 194 and a single finger 196 in the shroud opening. Upon actuation (as shown), an object may be grasped using the combination of the high flow vacuum and the actuation of the finger 196 (that may include friction enhancing material as shown) against the object. The end-effectors may therefore include one or more fingers positioned in a housing, where the pressure on the side of the finger generates a torque around the connection to the housing. This then moves the finger to make contact with an object and apply a force to resist the torque. This is the normal force on the grasp. The normal force and coefficient of friction together determine the frictional force. The fingers may be easily removed and changed during operation.

FIG. 23, for example, shows an end-effector 200 (without the shroud) that includes the vacuum port 70 that is coupled to a housing 202. From within the housing extend two fingers 204, 206 that are shorter and thinner than those of the end-effector 42 discussed above. The short and narrow fingers with a single slope are ideal for certain types of grips, while long, multi-sloped fingers offer additional capabilities.

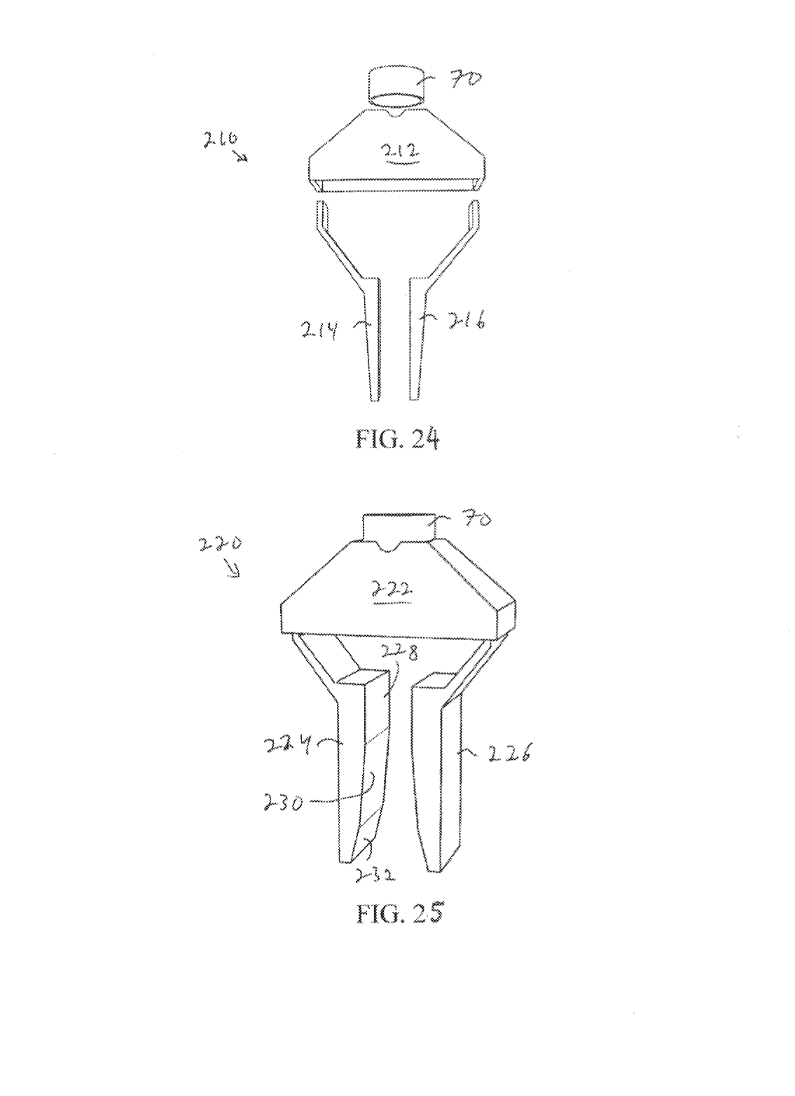

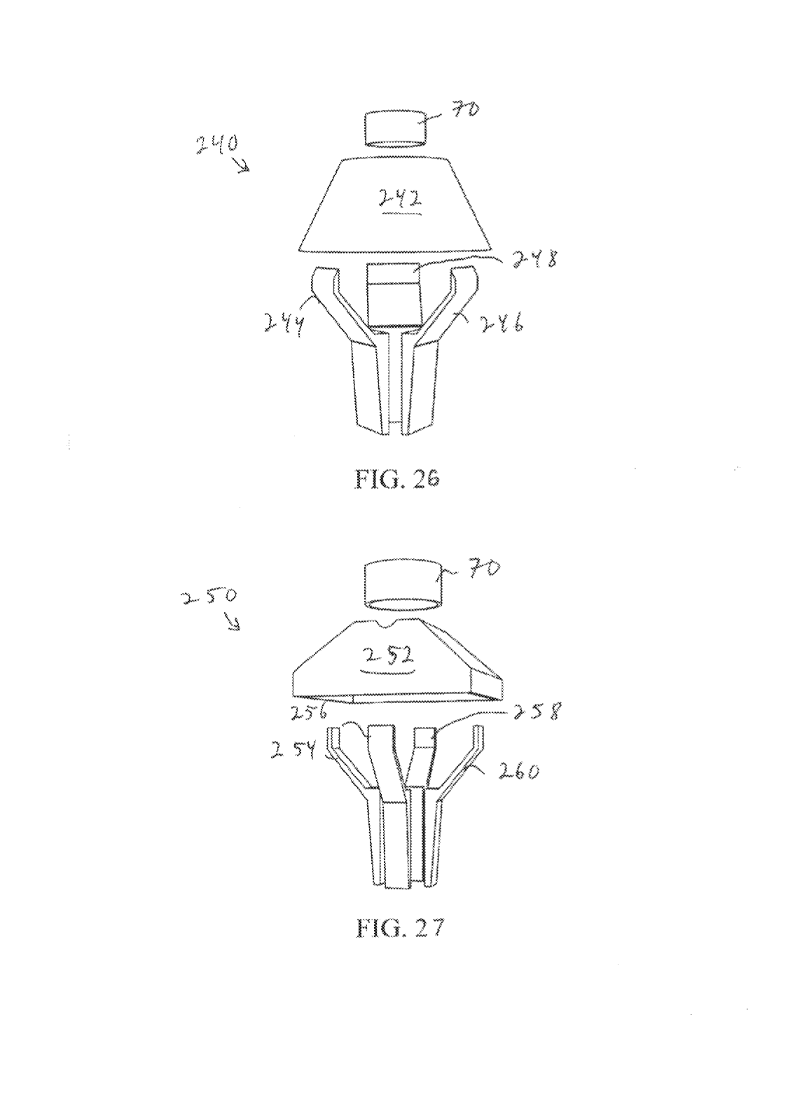

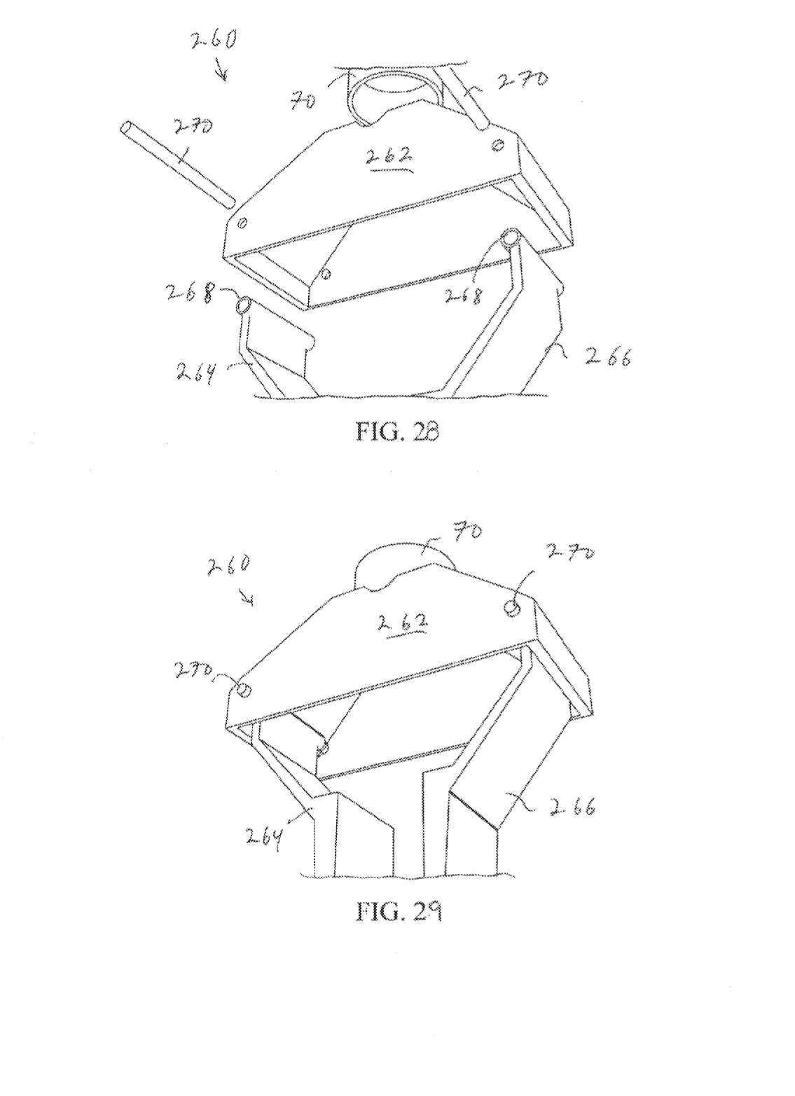

FIG. 24 shows an end-effector 210 (again without the shroud) that includes the vacuum port 70 that is coupled to a housing 212. From within the housing extend two fingers 214, 216 that are longer and thicker than those of the end-effector 42 discussed above. These longer fingers are particularly useful for wedging between objects. They are designed to be stiff against loads applied along their top surfaces, ensuring they do not easily deform under direct loading.

FIG. 25 shows an end-effector 220 (again without the shroud) that includes the vacuum port 70 that is coupled to a housing 222. From within the housing extend two fingers 224, 226 that are longer and thicker than those of the end-effector 42 discussed above. Each finger 224, 226 includes multiple differently sloped sections 228, 230, 232. The wider sections of these fingers are more efficient at converting pressure into torque for actuation, while the steeper sections allow for deeper reach into items and near walls.

In accordance with further aspects, end-effectors of the invention may include three or more fingers. FIG. 26 for example, shows an end-effector 240 that includes a housing 242 and three fingers 244, 246, 248 that extend from the housing 242, and are actuated as discussed above to provide forces on the object from three mutually non-opposing directions. The housing 242 is conically-shaped, and the proximal ends of each finger are shaped to attach to the inner wall of the conically-shaped housing. FIG. 27 shows an end-effector 250 that includes a housing 252 and four fingers 254, 256, 258, 260 that extend from the housing 252, and are actuated as discussed above to provide forces on the object from three mutually non-opposing directions. The housing 252 is square-shaped, and the proximal ends of each finger are attached to both sets of opposing inner walls of the square-shaped housing.

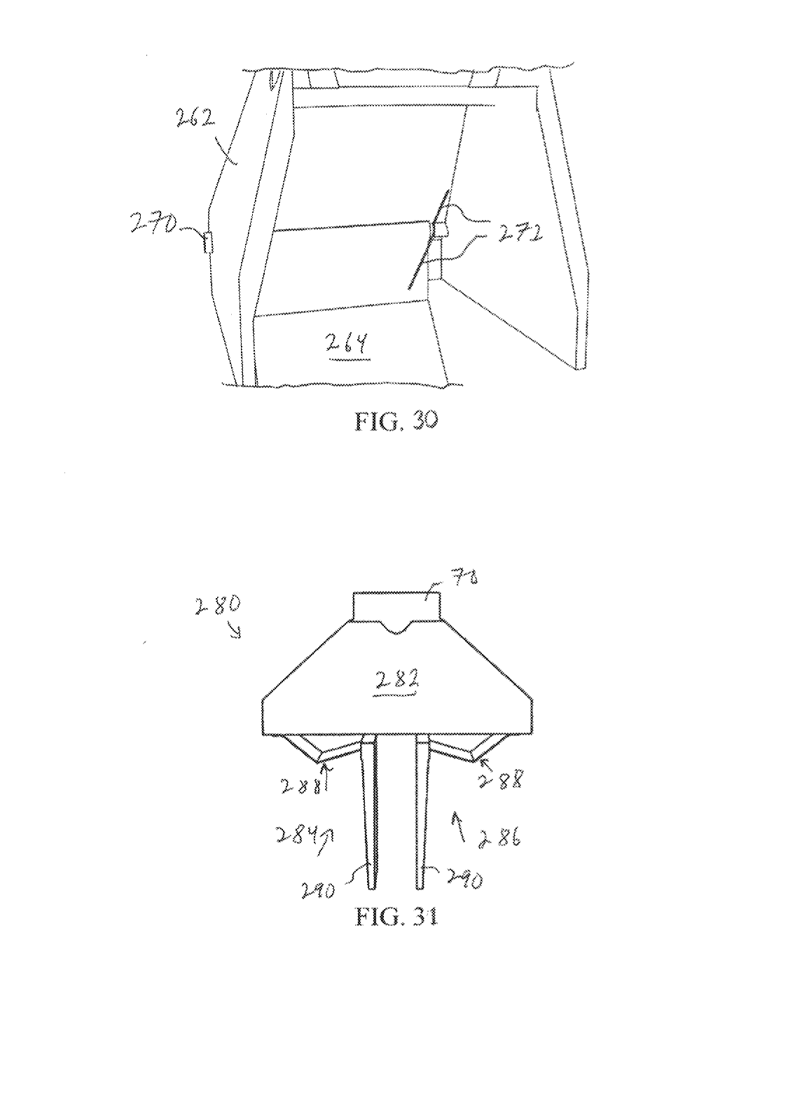

The proximal ends of the fingers of the end-effectors discussed above may be attached to the respective housings by any of screws, bolts, rivets, metal snaps, staples, adhesive, and hook and loop fasteners, etc. In accordance with further aspects, the proximal ends of fingers may include a channel for receiving a pivot rod that is mounted within the housing. FIGS. 28 and 29 show an end-effector 260 that includes a housing 262 and fingers 264, 266. FIG. 28 shows an exploded view and FIG. 29 shows the end-effector as assembled, both without the shroud for clarity. Each finger includes at its proximal end a channel 268 for receiving a rod 270 that is mounted within the housing. The fingers are therefore pivotally mounted within the housing, and under the force of the vacuum, the distal portions of the fingers may apply substantial pressure on a grasped object. In the event that the fingers do not readily return to their open position when the vacuum is removed, springs such as spring 272 may be included as shown in FIG. 30 to bias the fingers to be in the open position. As this may also reduce the grasping force on an object, the spring constant must be considered in view of the weight of the fingers and any resistance in the pivoting mechanism.

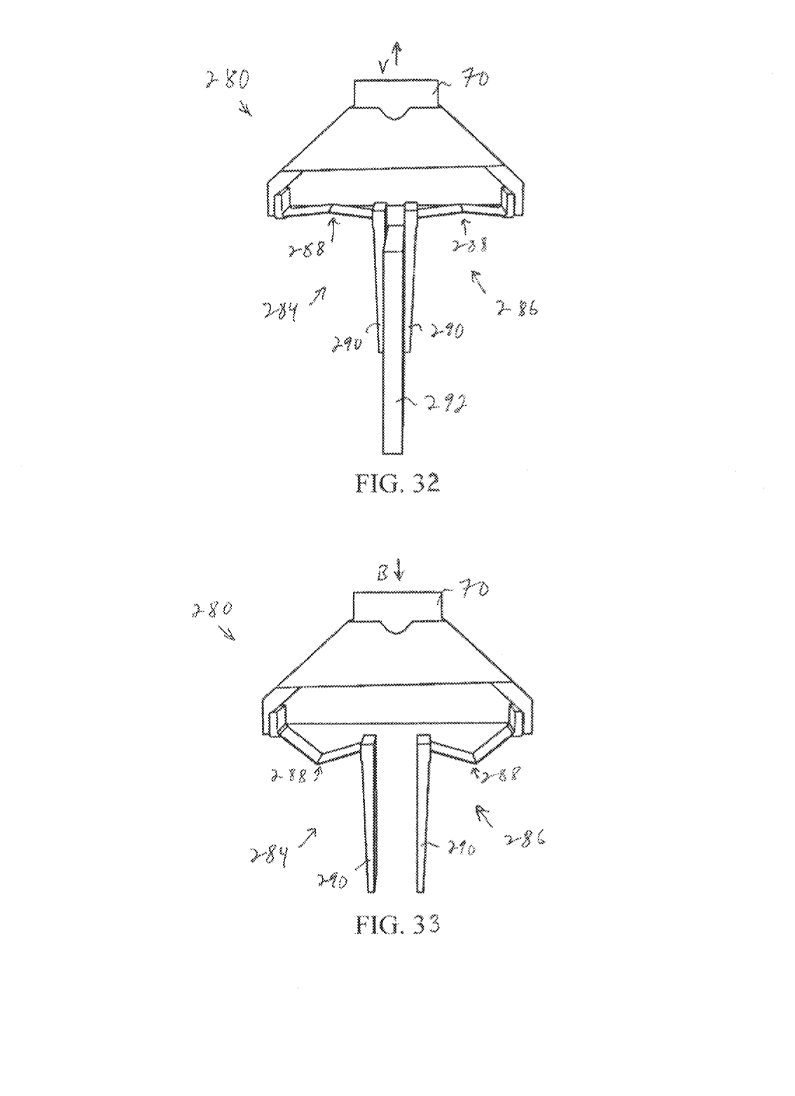

In accordance with further aspects, to further increase the gripping pressure of the fingers, snap sections may be included in the middle portion of the fingers. FIG. 31 shows an end-effector 280 that includes a housing 282 and fingers 284, 286 attached to the housing (with the surrounding shroud not shown for clarity). Each finger 284, 286 includes a middle portion 288 that is formed of a spring steel plate that is elastically movable between two positions. FIG. 32 shows the end-effector in a closed position with the shroud and a portion of the housing removed for clarity. The spring steel plates are pulled under the force of the vacuum (shown at V) to cause the distal portions 290 of the fingers to close onto an object 292. The gripping force may be particularly strong. With reference to FIG. 33, when the vacuum is switched to a blower (e.g., using a multistage valve) as shown at B, the force of the blower may urge the spring steel plate to return to its original position (shown also in FIG. 31) in which the distal portions 290 of the fingers 284, 286 are in the open position.

Those skilled in the art will appreciate that numerous modifications and variations may be made to the above disclosed embodiments without departing from the spirit and scope of the present invention.

1. An object processing system comprising:
an input area at which objects are presented to a programmable motion device, the programmable motion device including an end-effector attached thereto that is coupled to a vacuum source;
a perception system for providing perception data regarding an object to be processed that is at the input area; and
the end-effector including at least one finger that actuatable to move from a first position to a second position under a vacuum force in a vacuum direction provided by the vacuum source, the second position being adapted to apply a gripping force in a gripping direction that is generally transverse to the vacuum direction.

2. The object processing system of claim 1, wherein the at least one finger of the end-effector is provided as one of two fingers, each finger being actuatable to move from a first position to a second position under a vacuum force in a vacuum direction provided by the vacuum source, the second position being adapted to apply a gripping force in a gripping direction that is generally transverse to the vacuum direction.

3. The object processing system of claim 1, wherein the at least one finger of the end-effector is provided as one of three fingers, each finger being actuatable to move from a first position to a second position under a vacuum force in a vacuum direction provided by the vacuum source, the second position being adapted to apply a gripping force in a gripping direction that is generally transverse to the vacuum direction.

4. The object processing system of claim 1, wherein the at least one finger of the end-effector is provided as one of four fingers, each finger being actuatable to move from a first position to a second position under a vacuum force in a vacuum direction provided by the vacuum source, the second position being adapted to apply a gripping force in a gripping direction that is generally transverse to the vacuum direction.

5. The object processing system of claim 1, wherein the end-effector includes a shroud that covers a substantial portion of the at least one finger, the shroud facilitating the at least one finger being actuatable to move from the first position to the second position under the vacuum force in the vacuum direction provided by the vacuum source, the second position being adapted to apply the gripping force in the gripping direction that is generally transverse to the vacuum direction.

6. A vacuum actuated gripping end-effector comprising at least one finger that actuatable to move from a first position to a second position under a vacuum force in a vacuum direction provided by a vacuum source, the second position being adapted to apply a gripping force in a gripping direction that is generally transverse to the vacuum direction.

7. The vacuum actuated gripping end-effector of claim 6, wherein the at least one finger of the end-effector is provided as one of two fingers, each finger being actuatable to move from a first position to a second position under a vacuum force in a vacuum direction provided by the vacuum source, the second position being adapted to apply a gripping force in a gripping direction that is generally transverse to the vacuum direction.

8. The vacuum actuated gripping end-effector of claim 6, wherein the at least one finger of the end-effector is provided as one of three fingers, each finger being actuatable to move from a first position to a second position under a vacuum force in a vacuum direction provided by the vacuum source, the second position being adapted to apply a gripping force in a gripping direction that is generally transverse to the vacuum direction.

9. The vacuum actuated gripping end-effector of claim 6, wherein the at least one finger of the end-effector is provided as one of four fingers, each finger being actuatable to move from a first position to a second position under a vacuum force in a vacuum direction provided by the vacuum source, the second position being adapted to apply a gripping force in a gripping direction that is generally transverse to the vacuum direction.

10. The vacuum actuated gripping end-effector of claim 6, wherein the end-effector includes a shroud that covers a substantial portion of the at least one finger, the shroud facilitating the at least one finger being actuatable to move from the first position to the second position under the vacuum force in the vacuum direction provided by the vacuum source, the second position being adapted to apply the gripping force in the gripping direction that is generally transverse to the vacuum direction.

11. The vacuum actuated gripping end-effector of claim 10, wherein the shroud is formed of a flexible material that at least partially collapses under the force of the vacuum when the end-effector is gripping an object.

12. The vacuum actuated gripping end-effector of claim 6, wherein the at least one finger includes a vacuum channel that runs from a proximal end of a distal portion of the finger to a distal end of the distal portion of the end-effector to provide vacuum to a gripping surface of the distal end of the finger.

13. The vacuum actuated gripping end-effector of claim 12, wherein the at least one finger further includes a venting channel that runs from the gripping surface of the distal end of the finger to a backside of the distal end of the finger opposite the gripping surface.

14. The vacuum actuated gripping end-effector of claim 6, wherein the at least one finger includes a spring steel plate.

15. The vacuum actuated gripping end-effector of claim 6, wherein the vacuum source is a high flow vacuum source providing the vacuum at the end-effector with any of an air flow of at least about 100 cubic feet per minute or a vacuum pressure of no more than about 100,000 Pascals below atmospheric.

16. A method of processing objects using an end-effector of a programmable motion device, the method comprising:
providing a plurality of objects at an input area that is proximate the programmable motion device, the end-effector of the programmable motion device being coupled to a vacuum source;
providing perception data regarding an object to be processed that is at the input area; and
actuating at least one finger of the end-effector to move from a first position to a second position under a vacuum force in a vacuum direction provided by the vacuum source, the second position being adapted to apply a gripping force in a gripping direction that is generally transverse to the vacuum direction.

17. The method of claim 16, wherein the at least one finger of the end-effector is provided as one of two fingers, each finger being actuatable to move from a first position to a second position under a vacuum force in a vacuum direction provided by the vacuum source, the second position being adapted to apply a gripping force in a gripping direction that is generally transverse to the vacuum direction.

18. The method of claim 16, wherein the at least one finger of the end-effector is provided as one of three fingers, each finger being actuatable to move from a first position to a second position under a vacuum force in a vacuum direction provided by the vacuum source, the second position being adapted to apply a gripping force in a gripping direction that is generally transverse to the vacuum direction.

19. The method of claim 16, wherein the at least one finger of the end-effector is provided as one of four fingers, each finger being actuatable to move from a first position to a second position under a vacuum force in a vacuum direction provided by the vacuum source, the second position being adapted to apply a gripping force in a gripping direction that is generally transverse to the vacuum direction.

20. The method of claim 16, wherein the end-effector is selectively detachable from the programmable motion device and includes an alignment feature that maintains an orientation of the end-effector on the programmable motion device.
